(19) United States
(12) Patent Application Publication
(10) Pub. No.: US 2024/0286546 A1
(43) Pub. Date: Aug. 29, 2024

(54) CRITICAL STOP HANDLING FOR AUTONOMOUS VEHICLE

(71) Applicant: TuSimple, Inc., SAN DIEGO, CA (US)

(72) Inventor: Timothy Arthur JONES, Liberty Township, OH (US)

(21) Appl. No.: 18/441,868

(22) Filed: Feb. 14, 2024

Related U.S. Application Data
(60) Provisional application No. 63/487,558, filed on Feb. 28, 2023.

(51) Int. Cl. B60Q 1/50

(52) U.S. Cl. CPC B60Q 1/535; B60Q 1/507; B60Q 2400/20

(57) ABSTRACT

A method of operating an autonomous vehicle, comprising activating, by a processor on the autonomous vehicle, a first set of lights in response to determining that the autonomous vehicle has come to a stop due to a critical situation, wherein the first set of lights have an illumination intensity brighter than a second set of lights used in a non-critical situation, wherein the first set of lights form a pattern indicative of a size of the autonomous vehicle wherein the first set of lights are disposed on a base that is detachable from the autonomous vehicle.

### CROSS-REFERENCE TO RELATED APPLICATIONS

This document claims priority to and the benefit of U.S. Provisional Application No. 63/487,558, filed on Feb. 28, 2023. The aforementioned application of which is incorporated herein by reference in its entirety.

### TECHNICAL FIELD

This document relates to autonomous driving systems. In particular, described herein are systems and methods for providing visual alerts through ADS trailer emergency lights to vehicles following a stop of an autonomous vehicle in the middle of the road due to an unexpected situation or human-control operation.

### BACKGROUND

Self-driving or autonomous vehicles can be autonomously controlled to navigate along a path to a destination. Autonomous driving generally requires sensors and processing systems that take in the environment surrounding an autonomous vehicle and make decisions that ensure the safety of the autonomous vehicle and surrounding vehicles as well as other objects, both moving and stationary, around the autonomous vehicle. For example, these sensors include cameras and light detection and ranging (LiDAR) sensors that use light pulses to measure distances to various objects surrounding the autonomous vehicle.

### SUMMARY

Systems and methods described herein include features allowing an autonomous vehicle to activate, by a processor on the autonomous vehicle, a first set of lights in response to determining that the autonomous vehicle has come to a stop due to a critical situation, wherein the first set of lights have an illumination intensity brighter than a second set of lights used in a non-critical situation, wherein the first set of lights form a pattern indicative of a size of the autonomous vehicle, wherein the first set of lights are disposed on a base that is detachable from the autonomous vehicle.

The above and other aspects and features of the disclosed technology are described in greater detail in the drawings, the description, and the claims.

### BRIEF DESCRIPTION OF THE DRAWINGS

FIG. 1 illustrates a schematic diagram of a system including an autonomous vehicle, according to the disclosed technology.

FIG. 2 illustrates an example traffic scenario according to the disclosed technology.

FIGS. 3-4 illustrate examples of controlling the group of lights, according to the disclosed technology.

FIGS. 5-6 illustrate examples of patterns formed by the group of lights, according to the disclosed technology.

FIG. 7 shows a flowchart of an example method according to the disclosed technology.

FIG. 8 is a flowchart representation of a method in accordance with one or more embodiments of the present technology.

### DETAILED DESCRIPTION

Autonomous driving systems (also referred to as autonomous driving vehicles or autonomous vehicles) should safely accommodate all types of road configurations and conditions, including weather conditions (e.g., rain, snow, wind, dust storms, etc.), traffic conditions, and behaviors of other road users (e.g., vehicles, pedestrians, construction activities, etc.). Autonomous driving systems should make decisions about the speed and distance of traffic as well as about obstacles, including obstacles that obstruct the view of the autonomous vehicle's sensors. For example, an autonomous vehicle should estimate the distances between it and other vehicles, as well as the speeds and/or accelerations of those vehicles (e.g., relative to the autonomous vehicle and/or relative to each other; vehicle speed or acceleration can be determined in a certain system of coordinates, for example). Based on that information, the autonomous vehicle can decide whether or not it is safe to proceed along a planned path, when it is safe to proceed, and it also can make corrections to the planned path, if necessary. In various embodiments, speeds or velocities are determined and locations of objects or distances to the objects are determined. For simplicity, the following description uses speed, but velocity could also be determined, where velocity is a speed and a direction (is a vector). Also, although distance is used below, location (e.g., in a 2D or a 3D coordinate system) can be used as well.

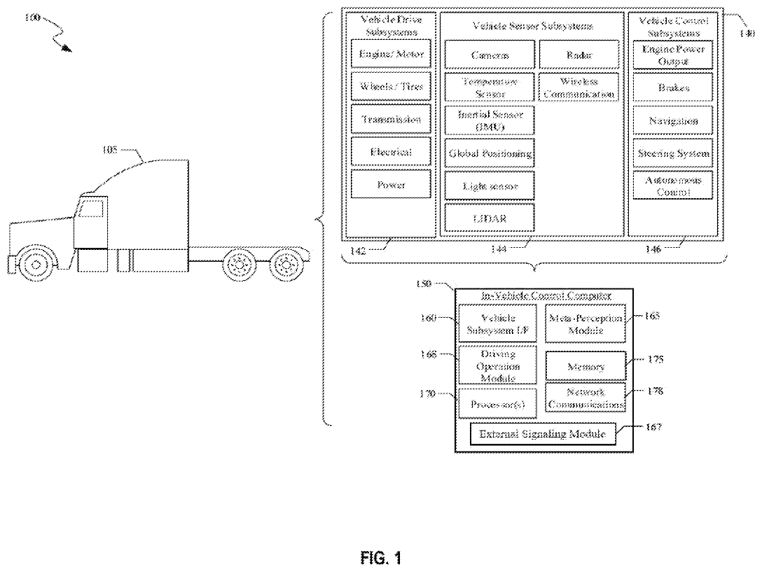

Examples of road configurations where these determinations and decisions should be made include so-called “T” intersections, so-called “Y” intersections, unprotected left turns, intersections with a yield where an autonomous vehicle (e.g., an autonomous truck) does not have the right-of-way, a roundabout, an intersection with stop signs where all traffic has to stop, and an intersection with four road sections and two stop signs where the autonomous vehicle must stop and other vehicles are not required to stop (e.g., cross-traffic does not stop), as well as many other road configurations. Examples of traffic conditions can include a vehicle tailgating the autonomous vehicle at a distance from the autonomous vehicle that the autonomous vehicle determines to be unsafe or potentially unsafe. For example, an autonomous vehicle may determine that a distance is unsafe if the distance is below a threshold value, which may be a predetermined distance value or a distance value determined by the autonomous vehicle based on traffic conditions, road conditions, speed of the vehicle following the autonomous vehicle relative to the speed of the autonomous vehicle, and/or a weight of the autonomous vehicle including the weight of goods (e.g., lumber, cars, furniture, corn, etc.) loaded in/on a trailer coupled to and transported by the autonomous vehicle. In some examples, the weight of the load and the trailer being transported/hauled by an autonomous vehicle can impact the performance of the autonomous vehicle. For example, an engine/motor of the vehicle drive subsystems 142 of FIG. 1, may have to generate more torque/power to move the load and the trailer compared to when there is no load and/or trailer transported by an autonomous vehicle 105 such as an autonomous tractor. The autonomous vehicle 105 may be embodied as an autonomous tractor, an autonomous truck, or the like vehicle that may operate autonomously, semi-autonomously, or by a human operator in the autonomous vehicle 105 or from a remote location. In another example, the brakes in the vehicle control subsystems 146 of FIG. 1, may have to be applied with greater force and/or for a longer period of time when the autonomous vehicle 105 is transporting the load and/or the trailer.

For all of the foregoing road configurations and traffic conditions, the autonomous vehicle must decide how it can safely proceed. To increase safety of the autonomous vehicle operation, the autonomous vehicle can provide visual and/or audio indications to other users on the road to help them stay a safe distance from the autonomous vehicle, for example.

According to some example embodiments, because of a non-compliant driver (e.g., a driver that drives erratically between the lanes) ahead of the autonomous vehicle, the autonomous vehicle might anticipate that it will need to apply its brakes suddenly or perform another sudden or aggressive maneuver at some point along its projected path. In such a situation, the autonomous vehicle can present a visual sign or signs on one or more locations on its body (e.g., back and/or sides) that alert other vehicles around it (e.g., that alert drivers of those vehicles) that the autonomous vehicle anticipates an upcoming situation where it might need to perform an aggressive/sudden maneuver (e.g., a sudden braking, an aggressive lane change, an aggressive acceleration, an aggressive deceleration, etc.) that can affect those vehicles. The visual sign can, for example, stay on until the potentially dangerous situation is eliminated, as determined by the autonomous vehicle. According to some example embodiments, the autonomous vehicle can also present visual signs to other vehicles indicating that they are in a spot with limited sensor reception by the autonomous vehicle (e.g., a “blind spot”) or that they are about to move into an area (e.g., sides or behind) around the autonomous vehicle where sensor perception of the autonomous vehicle is limited. Some implementations can provide signaling of the autonomous vehicle's intent via, e.g., an external visual indicator of what the autonomous vehicle's intent is (e.g., whether the vehicle is about to brake, change lanes, or perform some other maneuver).

Also, according to some example embodiments, when the autonomous vehicle is stopped at a traffic stop near a pedestrian crossing, it can generate visual and/or audio signals to acknowledge a pedestrian crossing the street along the pedestrian crossing (by, e.g., playing a pre-recorded message announcing that the autonomous vehicle is aware of the pedestrian's presence). Additionally, based on sensor data from sensors (e.g., scanning forward and rearward for other vehicles) on/in the AV, the AV may indicate to pedestrians that are on a sidewalk awaiting to cross the street that it may be safe to cross the street. For example, the AV may play a pre-recorded message announcing that those pedestrians can proceed to cross the street.

According to some example embodiments, an autonomous vehicle can display a sign for a tailgating vehicle indicating that the tailgating vehicle is too close to the autonomous vehicle. In some example embodiments, the sign can include a message indicating a distance at which it would be considered safe for other vehicles to follow the autonomous vehicle. Because the autonomous vehicle can typically obtain information about the surrounding environment a long distance ahead, it can instruct the vehicles following it (e.g., via displaying a visual sign for them) to keep at a safe distance from the autonomous vehicle. That safe distance can be determined by the autonomous vehicle based on, for example, information obtained by the autonomous vehicle from the surrounding environment using one or more sensors of the autonomous vehicle, a speed of the autonomous vehicle, a relative speed of the autonomous vehicle and another vehicle, or it can be a preset distance value. According to example embodiments, the safe distance can be updated by the autonomous vehicle (e.g., in a periodic manner). In some embodiments, visual indicators used by the autonomous vehicle (such as visual cue alerts for vehicles following the autonomous vehicle) may be based on sensor data of the autonomous vehicle. Visual indicators for a tailgating vehicle can be displayed on a rear part/surface of the autonomous vehicle, for example.

In the tailgating scenario, the autonomous vehicle can also display another sign indicating that the autonomous vehicle encourages the tailgating vehicle to pass the autonomous vehicle. For example, the AV may access data from its sensors indicating that there are no vehicles approaching the AV from a direction opposite from the AV. In some implementations, after a predefined time of opportunity for the tailgating vehicle to pass or to increase its distance from the autonomous vehicle has elapsed, if that vehicle continues to tailgate the autonomous vehicle, the autonomous vehicle can, for example, change lanes, or reduce or increase its speed within a proper speed limit to prevent a potential collision. In some implementations, the autonomous vehicle may display a sign for another vehicle only after that vehicle follows the autonomous vehicle at a distance less than a safe distance for a predetermined amount of time. In some example embodiments, the sign displayed by the autonomous vehicle to a tailgating vehicle can be a yellow light displayed on the back/rear side of the autonomous vehicle (or the back of the trailer that is connected to or is a part of the autonomous vehicle, back of a tractor, back of a passenger vehicle, etc.) indicating that the tailgating vehicle should increase its distance from the autonomous vehicle. That yellow light can turn green when the other vehicle increases its distance from the autonomous vehicle to a safe distance (predetermined or dynamically changing according to sensor data collected by the autonomous vehicle, for example). Providing the indicators to the vehicles following the autonomous vehicle may avoid rear-end collisions between the autonomous vehicles and other vehicles, for example.

In some example embodiments, when the autonomous vehicle is a tractor-trailer (e.g., a class 8 or other class vehicles), the autonomous vehicle can generate visual and/or audio warning signs when it performs a wide right turn to warn other vehicles following behind it in the same and/or other lanes of a road.

According to some example embodiments, when the autonomous vehicle is stopped at a traffic stop, it can indicate that it believes it is its turn to leave the stop by displaying a corresponding visual sign for other vehicles in the traffic stop area.

In some example embodiments, the autonomous vehicle can acknowledge that the autonomous vehicle understands directions given by a traffic controller at a road construction site or a police officer at an accident site by displaying corresponding visual signs and/or playing pre-recorded and/or ad hoc synthesized audio messages.

According to some example embodiments, an autonomous vehicle can display a sign or provide other means of visual indication that it is operating in autonomous mode. Such information can be helpful for other vehicles and/or their drivers that share the road with the autonomous vehicle.

In certain example embodiments, the autonomous vehicle can use visual indicators in addition to the standard turn indicators when it is about to do an aggressive lane change (e.g., when the projected amount of time between the start of the standard turn indication and the actual turn is less than a predetermined threshold value).

The types of means or devices that can be used by an autonomous vehicle to provide visual signs, icons, indicators or cues to vehicles (both autonomous and human-operated) as well as other road users (e.g., pedestrians, construction workers, law enforcement persons, etc.) around the autonomous vehicle according to various embodiments include but are not limited to: one or more light sources (also referred to as lights), e.g., static or flashing; a group or an array or a series of light sources (e.g., light-emitting diodes (LEDs)) that can display a sequence of lights varying in position, intensity and/or color; one or more liquid crystal displays (LCDs) that can display both static and dynamic visual information (e.g., animations). Audio signals, cues, and indicators, of varying intensity, according to the disclosed technology can be generated by one or more speakers that can be positioned at any location on or in the autonomous vehicle. In some embodiments, if an autonomous vehicle provides warning signals to a vehicle that is following the autonomous vehicle too closely, and that vehicle does not increase its distance from the autonomous vehicle, the autonomous vehicle may increase the intensity or frequency of the warning signals or provide different warning signals. For example, the warning signals may become brighter in color or luminosity and/or become louder in audio. The autonomous vehicle can obtain information about its surrounding environment using various sensors and devices, including but not limited to video cameras, LiDAR or RADAR (Radio Detection and Ranging) sensors, accelerometers, gyroscopes, inertial measurement units (IMUs), etc.

In current scenarios, when an autonomous vehicle is stopped at a traffic stop near a pedestrian crossing, it can generate regular visual signals from the rear lights to acknowledge a pedestrian or another vehicle. However, the regular visual signals from rear lights are not always visible enough to alert the passing by for at least the following reasons: 1) the rear lights alone do not indicate the size of the autonomous vehicle, 2) the rear lights are attached to the bottom side of a vehicle 3) the rear lights do not generate luminous lights bright enough. The present patent application aims to solve this problem. Specifically, this patent application proposes an attachable group of lights that can flexibly be attached and removed from any surface of a vehicle/trailer. The group of lights may form a pattern to generate flashing lights having an illumination intensity brighter than the regular rear lights, and the group of lights form a pattern indicative of the size of the autonomous vehicle,

FIG. 1 shows a system 100 that includes an autonomous vehicle 105. The autonomous vehicle 105 includes a plurality of vehicle subsystems 140 and an in-vehicle control computer (vehicle control unit) VCU 150. The plurality of vehicle subsystems 140 includes vehicle drive subsystems 142, vehicle sensor subsystems 144, and vehicle control subsystems 146. An engine or motor, wheels and tires, a transmission, an electrical subsystem, and a power subsystem may be included in the vehicle drive subsystems 142. The engine of the autonomous truck may be an internal combustion engine, a fuel-cell powered electric engine, a battery-powered electric engine, a hybrid engine, or any other type of engine capable of moving the wheels on which the autonomous vehicle 105 moves. The autonomous vehicle 105 can have multiple motors or actuators to drive the wheels of the vehicle. For example, vehicle drive subsystems 142 can include two or more electrically driven motors. The transmission of the autonomous vehicle 105 may include a continuously variable transmission or a set number of gears that translate the power created by the engine of the autonomous vehicle 105 into a force that drives the wheels of the autonomous vehicle 105. The vehicle drive subsystems 142 may include an electrical system that monitors and controls electrical current distribution to components within the system, including pumps, fans, and actuators. The power subsystem of the vehicle drive subsystems 142 may include components that regulate the power source of the autonomous vehicle 105.

Vehicle sensor subsystems 144 can include sensors for the general operation of the autonomous vehicle 105. The sensors for the general operation of the autonomous vehicle may include cameras, a temperature sensor, an inertial sensor (IMU), a global positioning system, a light sensor, a LIDAR system, a radar system, and wireless communications.

The vehicle control subsystems 146 may be configured to control the operation of the autonomous vehicle 105 and its components. Accordingly, vehicle control subsystems 146 may include various elements such as an engine power output subsystem, a brake unit, a navigation unit, a steering system, and an autonomous control unit. The engine power output may control the operation of the engine, including the torque produced or horsepower provided, as well as provide control of the gear selection of the transmission. The brake unit can include any combination of mechanisms configured to decelerate the autonomous vehicle 105. The brake unit can use friction to slow the wheels in a standard manner. The brake unit may include an anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from a GPS device and one or more predetermined maps so as to determine the driving path for the autonomous vehicle 105. The steering system may represent any combination of mechanisms that may be operable to adjust the heading of the autonomous vehicle 105 in an autonomous mode or in a driver-controlled mode.

The autonomous control unit may represent a control system configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some embodiments, the autonomous control unit may be configured to incorporate data from the GPS device, the RADAR, the LiDAR, the cameras, and/or other vehicle subsystems to determine the driving path or trajectory for the autonomous vehicle 105.

An in-vehicle control computer 150, which may be referred to as a vehicle control unit or VCU, can include, for example, any of: a vehicle subsystem interface 160, a driving operation module 168, one or more processors 170, a meta-perception module 165, a memory 175, an external signaling module 167, or a network communications subsystem 178. This in-vehicle control computer 150 may control many operations of the autonomous vehicle 105 in response to information available from the various vehicle subsystems 140. The one or more processors 170 execute the operations associated with the meta-perception module 165 that, for example, allow the system to determine confidence in perception data indicating a hazard, determine a confidence level of a regional map, and analyze the behavior of agents of interest (also referred as targets) surrounding the autonomous vehicle 105. According to some example embodiments, an agent of interest or a target can be one of another vehicle, a vehicle following the autonomous vehicle 105, a vehicle in a vicinity of the autonomous vehicle 105, a pedestrian, a construction zone, or a vehicle proximate to the autonomous vehicle 105. For example, the target may be within an intended maneuver zone around the autonomous vehicle. Data from vehicle sensor subsystems 144 may be provided to the meta-perception module 165 so that the course of action may be appropriately determined. Alternatively, or additionally, the meta-perception module 165 may determine the course of action in conjunction with another operational or control module, such as the driving operation module 168 or the external signaling module 167. According to some example embodiments, the external signaling module 167 can be configured to control signaling behaviors of the autonomous vehicle 105. According to some example embodiments, the signaling behaviors of the autonomous vehicle can be determined by the external signaling module 167 using, e.g., information provided by one or more sensors of the vehicle sensor subsystems 144. Example signaling behaviors of the autonomous vehicle 105 are described below.

The memory 175 may contain additional instructions as well, including instructions to transmit data to, receive data from, interact with, or control one or more of the vehicle drive subsystems 142, the vehicle sensor subsystems 144, or the vehicle control subsystems 146. The in-vehicle control computer (VCU) 150 may control the function of the autonomous vehicle 105 based on inputs received from various vehicle subsystems (e.g., the vehicle drive subsystems 142, the vehicle sensor subsystems 144, and the vehicle control subsystems 146). Additionally, the VCU 150 may send information to the vehicle control subsystems 146 to direct the trajectory, velocity, signalling behaviors, and the like, of the autonomous vehicle 105. The vehicle control subsystem 146 may receive a course of action to be taken from one or more modules of the VCU 150 and consequently relay instructions to other subsystems to execute the course of action.

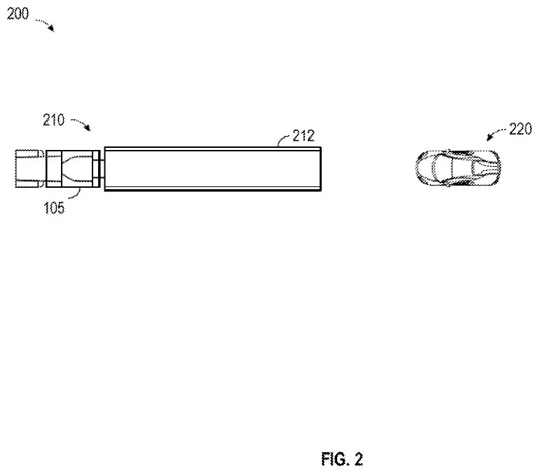

FIG. 2 discloses an example of use case for the disclosed technologies. For example, according to some example embodiments, FIG. 2 shows a traffic scenario 200. An autonomous vehicle 210 (e.g., similar to the autonomous vehicle 105), including a tractor and a trailer 212, is equipped with a control scheme to detect a critical situation and activate a group of lights to generate flashing lights. After detecting the critical situation, the autonomous vehicle 210 may activate a group of lights associated with a base to generate a flashing light to alert the other vehicle (220) on the road.

The critical situation can be detected and determined by a human-triggered controller or an autonomous controller. For example, a critical situation can be initiated by a driver.

In one example, a driver who determines to stop the vehicle in the middle of the road can activate the group of lights to alert other vehicles on the road that the autonomous vehicle has stopped in a manner that may impede other drivers' paths.

In another example, a critical situation can be indicated by a remote controller that is located remotely from the autonomous vehicle. For example, a remote controller may detect an autonomous vehicle encountering a stop on the road and activate the group of lights to warn the other vehicles on the road.

In yet another example, a critical situation can be detected by a sensor located on the autonomous vehicle. For example, a sensor detecting an unexpected stop of the autonomous vehicle on the road may activate the group of lights to alert the other vehicles on the road.

The group of lights can differ from regular lights attached to the autonomous vehicle used in a non-critical situation. For example, regular lights include the general rear lights or tail lights on the back of the vehicle, which are typically used according to motor vehicle regulations. A driver under non-critical situations usually triggers the regular rear lights or taillights. For example, a driver may activate the rear lights when reversing a car. In another example, a driver may activate the hazard lights (both front and rear) under foggy weather. In yet another example, a driver turns on the brake lights when stepping on the brake pedal.

The group of lights disclosed herein are different from the regular rear lights or taillights in at least three aspects.

First, the group of lights may not be fixed to a vehicle, compared to the real lights are usually fixed on the back side of a vehicle. Instead, the base containing the group of lights may be amenable to be readily detached and attached to any trailer or vehicle surface. In one example, the base with the group of lights is attached to the back side of a trailer at the beginning of the transportation and is removed when the trailer arrives at the destination. This attachable feature is beneficial because it increases the efficiency and flexibility of the system.

Second, the group of lights can be positioned into one of many different patterns, which greatly increases the visibility compared to the regular rear lights and taillights that are usually positioned at the bottom left and bottom right on the rear of a vehicle. In one example, the base containing the group of lights can be attached to cover an entire surface of a trailer or a vehicle. In another example, the base is attached along the edges of a trailer or a vehicle to allow other drivers to see the contours of the vehicle. In yet another example, the base can be attached to the top left and/or top right corner of a surface of a trailer or a vehicle. In yet another example, the base can be attached to multiple locations of a trailer or a vehicle.

Third, the group of lights may be visually different from the normal lights. For example, the group of lights may have different colors or an illumination intensity brighter than the regular rear lights or tail lights. This is beneficial because the brighter light makes it easier for the other vehicles driving behind or beside the stopped autonomous vehicle to notice the stopped autonomous vehicle. The brighter intensity of the lights also makes it easier for other drivers to distinguish the critical situation triggering the group of lights from the other non-critical situation. For example, as shown in FIG. 2, vehicle 220 is moving behind the autonomous vehicle 210 (e.g., in the same lane as the autonomous vehicle 210). When the autonomous vehicle 210 comes to a stop in the middle of the road due to a critical situation and activates the group of lights, vehicle 220 will notice, from the pattern and illumination intensity of the group of lights that 1) an object (e.g. the autonomous vehicle 210) has stopped in front and 2) able to discern that the object is of a size larger than a regular vehicle.

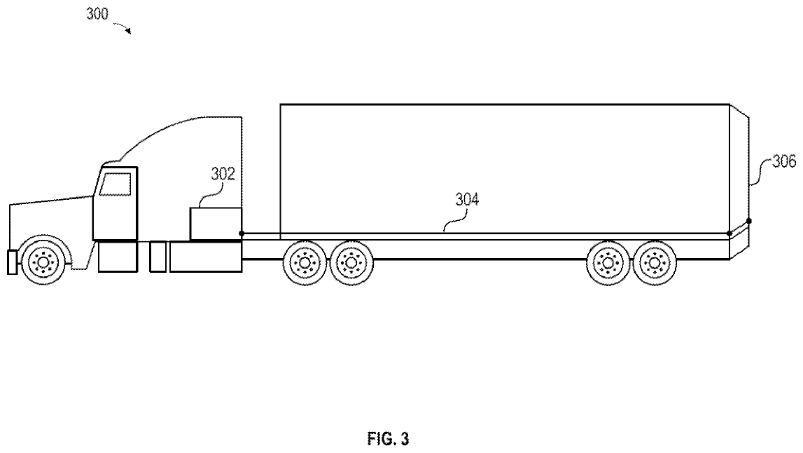

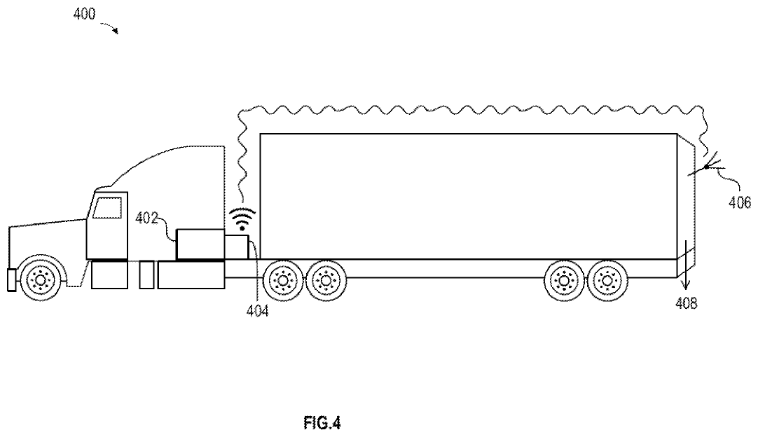

An existing module in the autonomous vehicle can control the group of lights. For example, a controller module located in the autonomous vehicle can activate the group of lights. The control of the group of lights can be through wired or wireless manners. FIGS. 3 and 4 show two examples under wired control and wireless control, respectively.

FIG. 3 shows an example of controlling the group of light in a wired manner, according to example embodiments. An autonomous vehicle 300 has a controller 302, a group of lights attached to a base 306, and a wire (304) connecting the controller (302) with the group of lights (attached to base 306, but shown in FIG. 3). The wire (304) can be of any material suitable for connection of short distance. For example, the wire (304) can be copper conductors separated by insulating material, on the outside of the inner insulating material is another layer of ring conductor and its insulator, and then the whole cable is covered by a sheath of PVC or Teflon material. Such coaxial cables can be used for the transmission of analog and digital signals and are suitable for a wide variety of applications, including short-distance connections between computer systems or modules. The wire can be positioned passing through the vehicle to connect the controller 302 located at the front of the vehicle and the base 306 located at the middle or back of the vehicle.

The communication on wire (304) can be either one-directional or a bi-directional. In other words, the controller and the group of lights can both send and receive signals transmitted on the wire. In one example, the communication on wire 304 is one way from the controller (302) to the base (306). For example, the controller (302) may send a trigger signal through the wire (304) to turn on the group of lights on the base (306). Similarly, the controller (302) may send another trigger signal through the wire (304) to turn off the group of lights on the base (306). In another example, the communication on wire 304 is one-directional from the base (306) to the controller (302). For example, the base (306) containing the group of lights may send feedback signals to the controller through the wire (304). The feedback signals can be but are not limited to, signals indicating the working status of the group of lights. For example, the feedback signals can be used for maintenance purposes to determine whether the base and the group of lights work under normal status. For example, a feedback signal may indicate the base is out of function. In another example, a feedback signal may indicate one or more of the group of lights are not working. In yet another example, a feedback signal may indicate a normal status for the base and the group of lights. Here, the feedback signals sent from the base (306) to the controller (302) can be a one-time signal or a periodic signal. In the latter case, the period of the feedback signals can be either pre-determined in the system or can be manually set.

FIG. 4 show an example of controlling the group of lights in a wireless manner, according to example embodiments. An autonomous vehicle 400 has a controller 402, two communication modules 404 and 406 and a group of lights 408 (not fully shown in FIG. 4), which can be attached to a surface of an autonomous vehicle or a trailer on the autonomous vehicle. The controller may communicate and/or control the group of lights through communication modules 404 and 406. The communication between the controller modules 404 and 406 can be conducted in any wireless technology adopted in short-distance communication scenarios. For example, one or a combination of the following wireless communication technologies can be assumed to achieve communication between the communication modules 404 and 406: 1) Wi-Fi, 2) Bluetooth, 3) ZigBee, 4) IrDA, 5) NFC, 6) ultra-wideband (UWB), 7) SIMpass. Similarly, the communication between the controller modules 404 and 406 can be compatible with any wireless communication standards, including but not limited to one or more of the following: 1) IEEE 802.11b (for Wi-Fi), 2) IEEE 802.11g (for Wi-Fi), 3) IEEE802.15.3.a (for UWB), 4) IEEE 802.15.1 (for Bluetooth), 5) IEEE802.15.4 (for ZigBee).

Communication module 404 may be attached to controller 402 or may be of a separate component. In one example, communication module 404 includes a transmitter that may send out a wireless communication signal to control the group of lights 408. In another example, is the communication module 404 from the group of lights 408. The wireless communication between the controller and the group of lights can be achieved through any suitable wireless standard/protocol, e.g., Wi-Fi or Bluetooth, and/or any other 802.11 wireless communication protocol or any other wireless communication standard/protocol.

Communication module 404 may include a transmitter for transmitting a wireless signal. In one example, communication module 404 has a transmitter configured to conduct a series of operations for transmitting a signal to communication module 406.

The first step is modulation: the signal to be transmitted must be modulated onto a carrier. Because the general signal frequency is low, it is not easy to transmit, and the carrier frequency is high, easy to transmit. The modulation adopted by module 404 can be but is not limited to, one of the following: a) amplitude modulation, adding the signal to the carrier so that the amplitude of the carrier changes with the signal, b) frequency modulation, adding the signal to the carrier, so that the frequency of the carrier changes with the signal, and 3) phase modulation, adding the signal to the carrier, so that the phase angle of the carrier changes with the signal. Module 404 can adopt either analog signal modulation or digital signal modulation.

The second step is amplifying: with the modulated signal, depending on the distance of the emission, it must be amplified. It is then sent to the open circuit for launch from radio waves.

Communication module 404 may also include a receiver for receiving a wireless signal. For example, communication module 404 has a receiver configured to identify and receive a signal transmitted from communication module 406.

Communication module 406 may be attached to the group of lights or may be of a separate component. In one example, communication module 406 includes a receiver that may receive a wireless communication signal sent from communication module 404. In another example, communication module 406 further comprises a transmitter that may conduct similar operation steps as disclosed for module 404 and send a request or feedback signal to the communication module 404.

The group of lights can be disposed of on a detachable base from the autonomous vehicle. This is beneficial since the flexibility of attaching and removing makes it easier to reuse the proposed system after a transmission. For example, a base containing a group of lights can be added to the vehicle's surface at the beginning of a journey and removed from the surface after the vehicle arrives at a destination. The same base can be immediately attached to another vehicle for a different transmission. The base can be of different forms. In one example, a base is one or multiple stripes that can be attached to the surface of the autonomous vehicle. The attachable feature can be achieved in different manners. In one example, the group of lights can be magnetically attached to a surface of a vehicle. In another example, the group of lights can be attached to a vehicle's surface through a sticky mechanism such as a peelable sticky surface or Velcro-type mechanism. In yet another example, the group of lights can be attached to a vehicle's surface through one or more hooks or other catching receptacles attached to the vehicle. In some examples, the group of lights can be attached/detached from the vehicle without needing any additional tools such as a screwdriver, a wrench etc. For example, the group of lights may be attached to the vehicle using the same mechanism that is also used to make an electrical connection with the wires on the vehicle that provide the electric power for lighting up the group of lights. Such a mechanism may include a socket into which pins on the back side of the group of lights may be pushed into for attachment.

The group of lights can be attached to any surface of the vehicle. And the group of lights are not limited to being attached to only one surface. In one example, a group of lights are attached to the back surface of a vehicle to alert the vehicles behind. In another example, a group of lights are attached to the side surfaces to alert the vehicles passing by. In yet another example, the group of lights are attached to both the back and side surfaces to increase the visibility of the autonomous vehicle. Even if the group of lights are attached to multiple surfaces, they can be selectively activated. For example, for an autonomous vehicle having a group of lights attached to both back and side surfaces, only the group of lights on the back surface are activated when the driver or the central controller selectively operates.

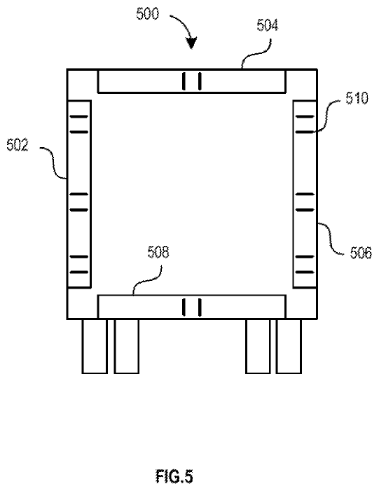

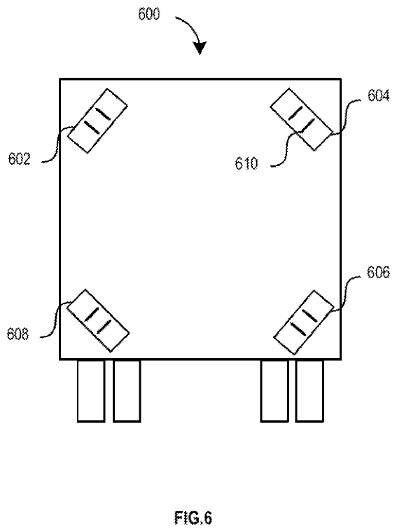

The group of lights may form a pattern indicative of the size of the autonomous vehicle. For example, the flashing pattern of the group of lights may indicate the width, height and/or length of the autonomous vehicle. This is beneficial since other vehicles can easily determine the size of the autonomous vehicle and be prepared to slow down or stop when approaching the autonomous vehicle. The pattern can be formed in different manners. Some example patterns are further illustrated in FIGS. 5-6.

FIG. 5 shows one possible pattern of the group of lights. As shown in FIG. 5, a surface 500 can be on any surface of an autonomous vehicle or a trailer on an autonomous vehicle. The group of lights may form a certain pattern on the surface 500. As shown in FIG. 5, the group of lights (510) are attached to multiple pieces (502, 504, 506, and 508) of a base. The four pieces are arranged along the four sides of the surface 500. Specifically, piece 502 is attached along the left side of surface 500; piece 504 is attached along the top side of surface 500; piece 506 is attached along the right side of surface 500; and piece 508 is attached along the bottom side of surface 500. Each piece of 502-508 has multiple lights attached to it. The group of lights, when activated, generate a flashlight indicating the size of the surface 500. This is beneficial because passing vehicles can easily tell the size of the autonomous vehicle by seeing the flashing light and preparing to slow down or stop when determining the autonomous vehicle is of huge size.

FIG. 6 shows another possible pattern of the group of lights. As shown in FIG. 6, a surface 600 can be on any surface of an autonomous vehicle or a trailer on an autonomous vehicle. The group of lights may form a certain pattern on the surface 600. As shown in FIG. 6, the group of lights (610) are attached to multiple pieces (602, 604, 606, and 608) of a base. The four pieces are arranged along the four corners of the surface 600. Specifically, piece 602 is attached along the top-left corner of surface 600; piece 604 is attached along the top-right corner of surface 600; piece 606 is attached along the bottom-right side of surface 600; and piece 608 is attached along the bottom-left side of surface 600. Each piece of 602-608 has multiple lights attached to it. The group of lights, when activated, generate a flashlight indicating the size of the surface 600, which is beneficial since a passing vehicle can easily recognize the size of the autonomous vehicle and prepare to slow down or stop when determining the autonomous vehicle is of huge size.

The group of lights can be made into different shapes. In one example, a slight is of square shape. In another example, light is of a round shape. In another example, light is of a rhombus shape. In yet another example, light is of a triangle shape. In yet another example, light is of a pentagram shape. The group of lights may have lights of the same shape or lights of different shapes. In one example, each light in the group of light is of the same shape, that can be one of the shapes listed in previous sections. In another example, the group of lights are of different shapes.

The group of lights can be made of any suitable material generating luminous lights. For example, the group of lights are LED lights. In one example, the group of lights are bi-Color LED lights. In another example, the group of lights are tri-color LED lights. In another example, the group of lights are Red Green Blue (RGB) LED lights. In yet another example, the group of lights are high-power LED. In yet another example, the group of lights are alphanumeric LEDs. In yet another example, the group of lights are made of a 7-segment LED that indicates a specific set of letters of numbers. In yet another example, the group of lights are made of 4 and 16-segment LEDs that indicate a particular message in the roman alphabet and numbers.

The group of lights may generate warning signals through changing flashing patterns. For example, the flashing patterns may change, e.g., long duration followed by short durations or vice versa. The purpose of changing flashing patterns is to increase the visibility of the stopped vehicle to the other vehicles on the road. In one example, the light group switches between an “on” duration and an “off” duration. The “on” duration may last for a period of time, e.g., several seconds. In another example, the two conservative “on” durations may have different lengths. For example, the group of lights may be on for 5 seconds, off for a while, and on again for 3 seconds.

The group of lights can generate lights of different colors. For example, the group of lights may flash with yellow, red, green, blue or another color. In another example In another example, different lights in the group of lights may generate light of different colors.

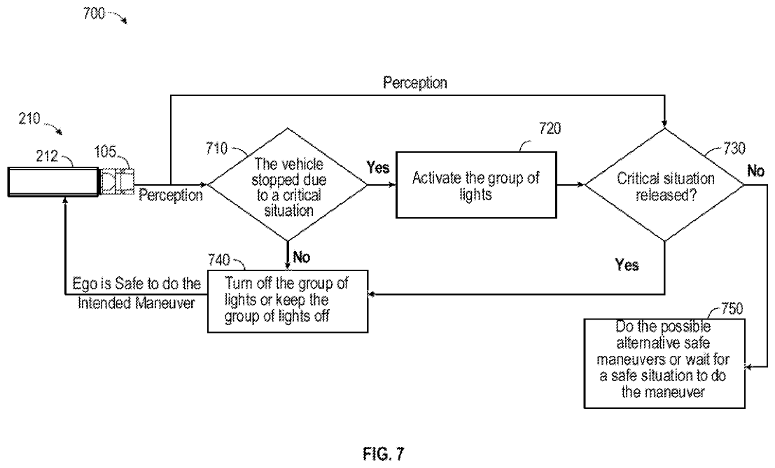

FIG. 7 shows a flowchart of an example method 700, according to example embodiments. The autonomous vehicle 210, shown in FIG. 7 may use data from its vehicle sensor subsystems 144 (e.g., various cameras and sensors such as LiDARs or RADARs) to sense or perceive its operation status but not limited to velocity, etc. In some examples, based on a critical situation, the autonomous vehicle 210 may reduce its speed or come to a sharp stop. The critical situation can be triggered due to an unexpected road condition or a traffic condition. In one example, a critical situation includes a car accident between the autonomous vehicle with another vehicle on the road. In another example, a critical situation includes a detection of a change in road conditions. In yet another example, a critical situation includes an indication to stop from a driver or from a remote controller.

At block 710 of flowchart 700, the method includes performing, by the autonomous vehicle 210, a determination as to whether the autonomous vehicle 210 stops due to a critical situation.

At block 720, method 700 includes activating, by the autonomous vehicle 210, the group of lights through a wired or wireless manner in response to determining that the autonomous vehicle comes to a stop due to a critical situation at block 710 of method 700. For example, the autonomous vehicle 210 may activate the group of lights by sending a signal on a wire connecting the base containing the lights and a controller. In another example, the autonomous vehicle 210 may activate the group of lights by sending a wireless signal from a transmitter on a controller to a receiver located on the base containing the group of lights.

At block 730, method 700 includes determining, by the autonomous vehicle 210 and based on perception information acquired by the autonomous vehicle 210, whether to turn off the group of lights due to a detection of the relief of the critical situation or an instruction from a human or a remote controller.

At block 740, method 700 includes determining, by the autonomous vehicle 210, that it is safe to turn off the group of lights in response to determining, by the autonomous vehicle 210 that the critical situation has been resolved at block 730 of the method 700, or in response to an instruction from a human or a central controller.

Block 750 of method 700 includes performing, by the autonomous vehicle 210, an alternative safe maneuver or waiting for a safe situation to perform the intended maneuver in response to determining that the critical situation was not resolved at block 730 of the method 700. For example, the autonomous vehicle 210 may determine, from its radar in the vehicle sensor subsystems 144, that the vehicle was still stopped in the middle of a highway. Under this case, the autonomous vehicle 210 may keep tracking the road condition and report the situation to a controller while keeping the group of lights on to alert the other vehicles on the road.

Various technical solutions that may be implemented by some embodiments include:

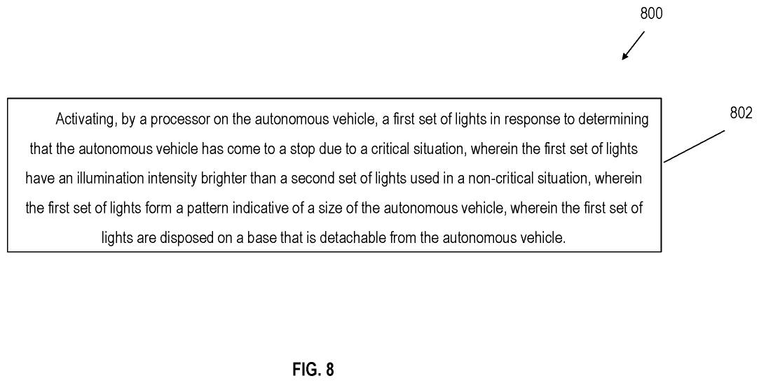

A method 800, as depicted in FIG. 8, of operating an autonomous vehicle, including activating (802), by a processor on the autonomous vehicle, a first set of lights in response to determining that the autonomous vehicle has come to a stop due to a critical situation, wherein the first set of lights have an illumination intensity brighter than a second set of lights used in a non-critical situation, wherein the first set of lights form a pattern indicative of a size of the autonomous vehicle, wherein the first set of lights are disposed on a base that is detachable from the autonomous vehicle.

In some embodiments, method 800 includes transmitting a signal by a transmitter of the autonomous vehicle; and receiving the signal, by a receiver of the autonomous vehicle, wherein the transmitter and the receiver are disposed on physically separate positions on the autonomous vehicle.

In some embodiments, method 800 includes generating a second signal indicating the second set of lights to be turned off; and turning off the second set of lights based on the second signal.

In some embodiments, the activating includes transmitting a signal on a wire connecting the second set of lights.

In some embodiments, the illumination intensity of the first set of lights is adjustable depending on the critical situation.

In some embodiments, the pattern comprises the first set of lights positioned at the corners of the surface of the autonomous vehicle.

In some embodiments, the pattern comprises the first set of lights positioned along sides of a surface of the autonomous vehicle.

In some embodiments, the base is magnetically attached to at least one surface of the autonomous vehicle.

In some embodiments, a system for autonomous driving operation comprises an autonomous vehicle that includes a plurality of subsystems configured to activate, by at least one of the plurality of subsystems, a first set of lights in response to determining that the autonomous vehicle has come to a stop due to a critical situation, wherein the first set of lights have an illumination intensity brighter than a second set of lights used in a non-critical situation, wherein the first set of lights forms a pattern indicative of a size of the autonomous vehicle, wherein the first set of light are disposed on a base that is detachable from the autonomous vehicle.

In some embodiments, at least one of the plurality of subsystems is further configured to transmit a signal, by at least one of the plurality of subsystems; and receive the signal, by at least one of the plurality of subsystems.

In some embodiments, at least one of the plurality of subsystems is further configure to: generate, by at least one of the plurality of subsystems, a second signal indicating the lights to be turned off; and turn off , by at least one of the plurality of subsystems, the lights based on the second signal.

In some embodiments, the critical situation comprises a sharp stop on a middle of a road.

In some embodiments, the critical situation comprises a gradual stop on a middle of a road.

In some embodiments, the at least one subsystem comprises a controller located at the base.

It will be appreciated by one of skill in the art that the present document provides several techniques for safely operating an autonomous vehicle when a critical condition is detected. Upon detecting the critical condition, lights external to the autonomous vehicle may be activated such that other drivers may be able to see the entire end-to-end dimension of the autonomous vehicle based on the edges of the lights. In some example embodiments, the lights may have a different intensity and color than the lights that are normally installed on vehicles. In some embodiments, the lights may be mounted on a removable fixture such that the lights may be readily attached to and removed from the autonomous vehicle without the need of tools like a screwdriver or a wrench.

A non-transitory machine-useable storage medium embodying instructions which, when executed by a machine, cause the machine to. activate a first set of lights in response to determining that an autonomous vehicle has come to a stop due to a critical situation, wherein the first set of light have an illumination intensity brighter than a second set of lights used in a non-critical situation, wherein the first set of lights forms a pattern indicative of a size of the autonomous vehicle, wherein the first set of lights are disposed on a base that is detachable from the autonomous vehicle.

In the non-transitory machine-useable storage medium, the first set of lights are LED lights.

In the non-transitory machine-useable storage medium, the first set of lights generate warning signals through changing lighting color, lighting strength, or flashing pattern.

In the non-transitory machine-useable storage medium, the base covers at least one surface of the autonomous vehicle.

In the non-transitory machine-useable storage medium, the surface is a back surface of the autonomous vehicle.

In the non-transitory machine-useable storage medium, the surface is a side surface of the autonomous vehicle.

Implementations of the subject matter and the functional operations described in this document can be implemented in various systems, semiconductor devices, ultrasonic devices, digital electronic circuitry, or in computer software, firmware, or hardware, including the structures disclosed in this specification and their structural equivalents, or in combinations of one or more of them. Implementations of aspects of the subject matter described in this specification can be implemented as one or more computer program products, e.g., one or more modules of computer program instructions encoded on a tangible and non-transitory computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

In this disclosure, LiDAR and LIDAR are used to refer to light detection and ranging devices and methods, and alternatively, or additionally, laser detection and ranging devices and methods. The use of these acronyms does not imply limitation of the described devices, systems, or methods to the use of one over the other.

While this document contains many specifics, these should not be construed as limitations on the scope of any invention or of what may be claimed, but rather as descriptions of features that may be specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this document should not be understood as requiring such separation in all embodiments.

Only some implementations and examples are described, and other implementations, enhancements and variations can be made based on what is described and illustrated in this document.

What is claimed is:

1. A method of operating an autonomous vehicle, comprising:
activating, by a processor on the autonomous vehicle, a first set of lights in response to determining that the autonomous vehicle has come to a stop due to a critical situation,
wherein the first set of lights have an illumination intensity brighter than a second set of lights used in a non-critical situation,
wherein the first set of lights form a pattern indicative of a size of the autonomous vehicle,
wherein the first set of lights are disposed on a base that is detachable from the autonomous vehicle.

2. The method of operating an autonomous vehicle according to claim 1, wherein the activating includes:
transmitting a first signal by a transmitter of the autonomous vehicle; and
receiving the first signal, by a receiver of the autonomous vehicle, wherein the transmitter and the receiver are disposed at physically separate positions on the autonomous vehicle.

3. The method of operating an autonomous vehicle according to claim 1, wherein the activating includes:
transmitting a second signal indicating the second set of lights to be turned off; and
turning off the second set of lights based on the second signal.

4. The method of operating an autonomous vehicle according to claim 1, wherein the activating includes:
transmitting a signal on a wire connecting the second set of lights.

5. The method of operating an autonomous vehicle according to claim 1, wherein the illumination intensity of the first set of lights is adjustable depending on the critical situation.

6. The method of operating an autonomous vehicle according to claim 5, wherein the pattern comprises the first set of lights positioned at corners of a surface of the autonomous vehicle.

7. The method of operating an autonomous vehicle according to claim 5, wherein the pattern comprises the first set of lights positioned along sides of a surface of the autonomous vehicle.

8. The method of operating an autonomous vehicle according to claim 1, wherein the base is magnetically attached to at least one surface of the autonomous vehicle.

9. A system for autonomous driving operation, comprising:
an autonomous vehicle comprising a plurality of subsystems configured to:
activate, by at least one of the plurality of subsystems, a first set of lights in response to determining that the autonomous vehicle has come to a stop due to a critical situation,
wherein the first set of lights have an illumination intensity brighter than a second set of lights used in a non-critical situation,
wherein the first set of lights forms a pattern indicative of a size of the autonomous vehicle,
wherein the first set of light are disposed on a base that is detachable from the autonomous vehicle.

10. The system for autonomous driving operation according to claim 9, wherein the at least one of the plurality of subsystems are further configure to.
transmit a first signal, by at least one of the plurality of subsystems; and
receive the first signal, by at least one of the plurality of subsystems.

11. The system for autonomous driving operation according to claim 9, wherein the at least one of the plurality of subsystems are further configure to:
transmitting, by at least one of the plurality of subsystems, a second signal indicating the lights to be turned off; and
turn off, by at least one of the plurality of subsystems, the lights based on the second signal.

12. The system for autonomous driving operation according to claim 9, wherein the critical situation comprises a sharp stop on a middle of a road.

13. The system for autonomous driving operation according to claim 9, wherein the critical situation comprises a gradual stop on a middle of a road.

14. The system for autonomous driving operation according to claim 9, wherein the at least one subsystem comprises a controller located at the base.

15. A non-transitory machine-useable storage medium embodying instructions which, when executed by a machine, cause the machine to:
activate a first set of lights in response to determining that an autonomous vehicle has come to a stop due to a critical situation,
wherein the first set of light have an illumination intensity brighter than a second set of lights used in a non-critical situation,
wherein the first set of lights forms a pattern indicative of a size of the autonomous vehicle,
wherein the first set of lights are disposed on a base that is detachable from the autonomous vehicle.

16. The non-transitory machine-useable storage medium according to claim 15, wherein the first set of lights are LED lights.

17. The non-transitory machine-useable storage medium according to claim 15, wherein the first set of lights generate warning signals through changing lighting color, lighting strength, or flashing pattern.

18. The non-transitory machine-useable storage medium according to claim 15, wherein the base covers at least one surface of the autonomous vehicle.

19. The non-transitory machine-useable storage medium according to claim 18, wherein the surface is a back surface of the autonomous vehicle.

20. The non-transitory machine-useable storage medium according to claim 18, wherein the surface is a side surface of the autonomous vehicle.
